(19) United States
(12) Patent Application Publication
(10) Pub. No.: US 2006/0282494 A1
(43) Pub. Date: Dec. 14, 2006

(54) INTERACTIVE WEB CRAWLING

(76) Inventors: Caleb Sima, Woodstock, GA (US); Raymond Kelly, Loganville, GA (US); Steve Millar, Dawsonville, GA (US); Robert Raboud, Atlanta, GA (US); Bryan Sullivan, Duluth, GA (US); Jerry Sullivan, Roswell, GA (US); David Tillery, Woodstock, GA (US)

Correspondence Address: SMITH FROHWEIN TEMPEL GREENLEE BLAHA, LLC, P.O. BOX 88148, ATLANTA, GA, 30356, US

(21) Appl. No.: 11/461,767

(22) Filed: Aug. 1, 2006

Related U.S. Application Data
(63) Continuation-in-part of application No. 11/056,928, filed on Feb. 11, 2005.
(60) Provisional application No. 60/543,626, filed on Feb. 11, 2004.

(51) Int. Cl. H04L 9/32

(52) U.S. Cl. 709/200

(57) ABSTRACT

A crawler that is either based on an interactive mode of operation or includes an interactive mode along with one or more other modes, such as automatic or manual. Similar to an automatic mode crawler, the crawler traverses web sites, web content and links. However, if the crawler encounters a structure that requires human interaction, such as a form, a radio button selector, a drop down selector, a human verification test, etc., the crawler pauses and prompts a user to take action.

### CROSS-REFERENCE TO RELATED APPLICATIONS

This application for a United States patent is a continuation-in-part of United States Patent Application entitled SYSTEM AND METHOD FOR TESTING WEB APPLICATIONS WITH RECURSIVE DISCOVERY AND ANALYSIS filed on Feb. 11, 2005 and assigned Ser. No. 11/056,928, which claims the benefit of the filing date of United States Provisional Application for patent that was filed on Feb. 11, 2004 with the title of “SYSTEM AND METHOD FOR TESTING WEB APPLICATIONS WITH RECURSIVE DISCOVERY AND ANALYSIS” and assigned Ser. No. 60/543,626.

### BACKGROUND OF THE INVENTION

The present invention relates to the field of web site analysis and, more specifically, to a crawling technique that includes an interactive mode to enhance data input capabilities.

In the world of high-tech, electronics and computer systems, as well as almost every consumer electronics device, the key marketing thrust is “make it smaller”. Thus, the electronic products available to use are constantly shrinking in size. However, there are two aspects of the high-tech industry that are not only refusing to shrink, but indeed are actually growing at quite a rapid rate. These two aspects include memory capacities and software program and/or data. Fortunately, the physical sizes of memory devices are shrinking. It would be quite a daunting sight to see a 600 Gigabyte drive 15 years ago.

And what is all this memory being used for? A good portion of it is being consumed by increasingly sophisticated and complex web sights. The typical 1-2 Megabyte, limited page web site is being replaced by huge, intricate and detailed web sites full of web applications, data stores, information and the like.

Unfortunately, the free exchange of information, so easily facilitated by personal computers over the Internet, has spawned a variety of risks for the organizations that host that information. This threat is most prevalent in interactive applications hosted on the World Wide Web and accessible by almost any personal computer located anywhere in the world. Web applications can take many forms: an informational Web site, an intranet, an extranet, an e-commerce Web site, an exchange, a search engine, a transaction engine, or an e-business. These applications are typically linked to computer systems that contain weaknesses that can pose risks to a company. Weaknesses can exist in system architecture, system configuration, application design, implementation configuration, and operations. The risks include the possibility of incorrect calculations, damaged hardware and software, data accessed by unauthorized users, data theft or loss, misuse of the system, and disrupted business operations.

As the digital enterprise embraces the benefits of e-business, the use of Web-based technology will continue to grow. Corporations today use the Web as a way to manage their customer relationships, enhance their supply chain operations, expand into new markets, and deploy new products and services to customers and employees. However, successfully implementing the powerful benefits of Web-based technologies can be greatly impeded without a consistent approach to Web application security.

It may surprise industry outsiders to learn that hackers routinely attack almost every commercial Web site, from large consumer e-commerce sites and portals to government agencies such as NASA and the CIA. In the past, the majority of security breaches occurred at the network layer of corporate systems. Today, however, hackers are manipulating Web applications inside the corporate firewall, enabling them to access and sabotage corporate and customer data. Given even a tiny hole in a company's Web-application code, an experienced intruder armed with only a Web browser (and a little determination) can break into most commercial Web sites.

The problem is much greater than industry watchdogs realize. Many U.S. businesses do not even monitor online activities at the Web application level. This lack of security permits even attempted attacks to go unnoticed. It puts the company in a reactive security posture, in which nothing gets fixed until after the situation occurs. Reactive security could mean sacrificing sensitive data as a catalyst for policy change.

A new level of security breach has begun to occur through continuously open Internet ports (port 80 for general Web traffic and port 443 for encrypted traffic). Because these ports are open to all incoming Internet traffic from the outside, they are gateways through which hackers can access secure files and proprietary corporate and customer data. While rogue hackers make the news, there exists a much more likely threat in the form of online theft, terrorism, and espionage.

Today the hackers are one step ahead of the enterprise. While corporations rush to develop their security policies and implement even a basic security foundation, the professional hacker continues to find new ways to attack. Most hackers are using “out-of-the-box” security holes to gain escalated privileges or execute commands on a company's server. Simple misconfigurations of off-the-shelf Web applications leave gaping security vulnerabilities in an unsuspecting company's Web site.

Passwords, SSL and data-encryption, firewalls, and standard scanning programs may not be enough. Passwords can be cracked. Most encryption protects only data transmission; however, the majority of Web application data is stored in a readable form. Firewalls have openings. Scanning programs generally check networks for known vulnerabilities on standard servers and applications, not proprietary applications and custom Web pages and scripts.

Programmers typically don't develop Web applications with security in mind. What's more, most companies continue to outsource the majority of their Web site or Web application development using third-party development resources. Whether these development groups are individuals or consultancies, the fact is that most programmers are focused on the “feature and function” side of the development plan and assume that security is embedded into the coding practices. However, these third-party development resources typically do not have even core security expertise. They also have certain objectives, such as rapid development schedules, that do not lend themselves to the security scrutiny required to implement a “safe solution.”

Manipulating a Web application is simple. It is often relatively easy for a hacker to find and change hidden form fields that indicate a product price. Using a similar technique, a hacker can also change the parameters of a Common Gateway Interface (CGI) script to search for a password file instead of a product price. If some components of a Web application are not integrated and configured correctly, such as search functionality, the site could be subject to buffer-overflow attacks that could grant a hacker access to administrative pages. Today's Web-application coding practices largely ignore some of the most basic security measures required to keep a company and its data safe from unauthorized access.

Developers and security professionals must be able to detect holes in both standard and proprietary applications. They can then evaluate the severity of the security holes and propose prioritized solutions, enabling an organization to protect existing applications and implement new software quickly. A typical process involves evaluating all applications on Web-connected devices, examining each line of application logic for existing and potential security vulnerabilities.

A Web application attack typically involves five phases: port scans for default pages, information gathering about server type and application logic, systematic testing of application functions, planning the attack, and launching the attack. The results of the attack could be lost data, content manipulation, or even theft and loss of customers.

A hacker can employ numerous techniques to exploit a Web application. Some examples include parameter manipulation, forced parameters, cookie tampering, common file queries, use of known exploits, directory enumeration, Web server testing, link traversal, path truncation, session hijacking, hidden Web paths, Java applet reverse engineering, backup checking, extension checking, parameter passing, cross-site scripting, and SQL injection.

Assessment tools provide a detailed analysis of Web application and site vulnerabilities. FIG. 1 is a system diagram of a typical structure for an assessment tool. Through the Web Assessment Interface 100, the user designates which application, site or Web service resident on a web server or destination system 110 available over network 120 to analyze. The user selects the type of assessment, which policy to use, enters the URL, and then starts the process.

The assessment tool uses software agents 130 to conduct the vulnerability assessment. The software agents 130 are composed of sophisticated sets of heuristics that enable the tool to apply intelligent application-level vulnerability checks and to accurately identify security issues while minimizing false positives. The tool begins the crawl phase of the application using software agents to dynamically catalog all areas. As these agents complete their assessment, findings are reported back to the main security engine through assessment database 140 so that the results can be analyzed. The tool then enters an audit phase by launching other software agents that evaluate the gathered information and apply attack algorithms to determine the presence and severity of vulnerabilities. The tool then correlates the results and presents them in an easy to understand format to the reporting interface 150.

However, Web sites that extend beyond the rudimentary level of complexity that simply includes HTML to be rendered by a browser, can include a variety of sophisticated elements such as JAVA code, applets, Web applications, etc. The traditional approach of crawling through the HTML of a Web site is limited in the amount of information that can be obtained and analyzed. For instance, a Web site may include a PDF file that includes, within the text of the PDF file, additional links. The traditional Web crawler technology may obtain the link to the PDF file during the crawling phase of the attack, but the links embedded within the PDF file would be ignored during the second phase of the attack.

FIG. 2 is a block diagram showing the flow of operations for a prior art system that conducts a two-phased vulnerability assessment including a crawling phase and an auditing phase. Initially, a crawler 210 is configured 201 to initiate the crawling phase of the assessment. Once configured, the crawler 210 begins making discovery requests 202 to the web server 200. Each request results in a response 203 which is then stored into database 230. Feedback 204 may be provided to the crawler 210 to further configure or augment the operation of the crawler 210. Thus, the crawling phase consists of multiple trips through the process identified as Loop 1 which consists of multiple sessions, where each session includes a discovery request 202 followed by a response 203 and possible feedback 204.

Once the crawling phase is completed, the auditing phase commences. During the auditing phase, the auditor 220 is configured 205 based on data stored in database 230 during the crawling phase. The auditor 220 then makes attack requests 206 against the web server 200. Each attack request results in obtaining a response 207 which is then stored into the database 230. Thus, the auditing phase consists of one or more trips through the process identified as Loop 2 which consists of one or more sessions, where each session includes an attack request 206 followed by a response 207 and further configuration 205 as necessary.

As described in the parent application, the crawling process can be quite intensive and, if a recursive crawl is implemented, the amount of data accumulated during the discovery and response sessions can be quite large. In addition, many web sites now contain content that require user interaction. The use of forms, drop down boxes, radio button selections, human verification inputs, etc. can result in the crawling process becoming exceedingly complex and involved. In some instances, the crawling process can potentially be impossible to automate. For instance, pre-loading of information for free-text fields of a form could actually utilize an infinite number of inputs. In addition, human verification techniques cannot be anticipated and thus, cannot be pre-loaded for an automatic scan. It would be beneficial to enable a user to exert some level of control or direction over the crawling process to handle these, and other scenarios. However, as previously described, some web site structures are so complicated and large that it may take many hours or even days to complete the crawling process. Using automated crawling mode can greatly decrease the amount of time required to complete such a crawl.

Thus, there is a need in the art for a crawler, that can be deployed within a vulnerability assessment tool, and that includes an interactive mode that allows a user to provide direction and control over the crawling process, that can help expedite and focus the crawling process, but that does not prevent the advancement of the crawling process in an unacceptable manner. A primary goal of an automated crawler is to run at machine speed during intervals that do not require user input and to pause for input only when needed

### SUMMARY OF THE INVENTION

In general, the present invention includes a technique for conducting a crawl of a target object, such as a web site, a web application or the like. More specifically, one embodiment of the present invention provides an interactive crawling technique in which a user is prompted or offered to provide input at various stages in the crawling process. In another embodiment, a multi-mode crawler includes an interactive mode that is invoked upon the occurrence of one or more events. The events that invoke the interactive mode can include a variety of events depending on the specifics of the embodiment. Typical events may include, but are not limited to encountering a form, a radio button selector, a drop down box requiring a multiple choice input, a human verified input field, etc. or even may be invoked by a user action.

### BRIEF DESCRIPTION OF THE DRAWINGS

FIG. 1 is a system diagram of a typical structure for an assessment tool.

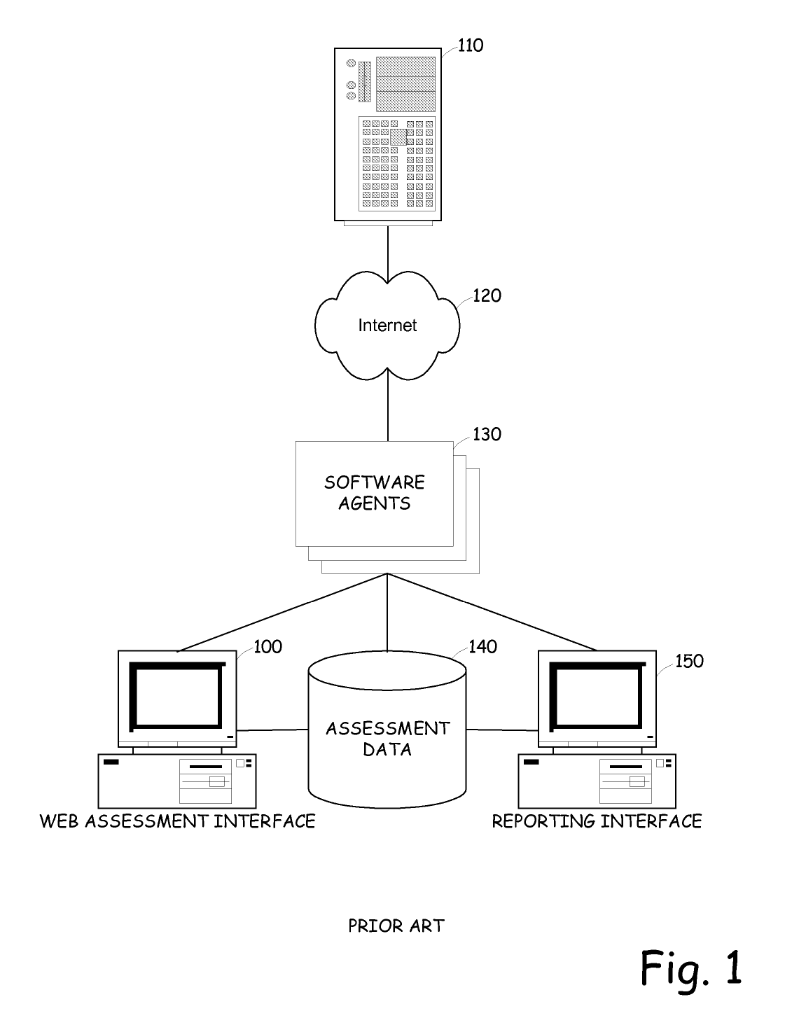

FIG. 2 is a block diagram showing the flow of operations for a prior art system that conducts a two-phased vulnerability assessment including a crawling phase and an auditing phase.

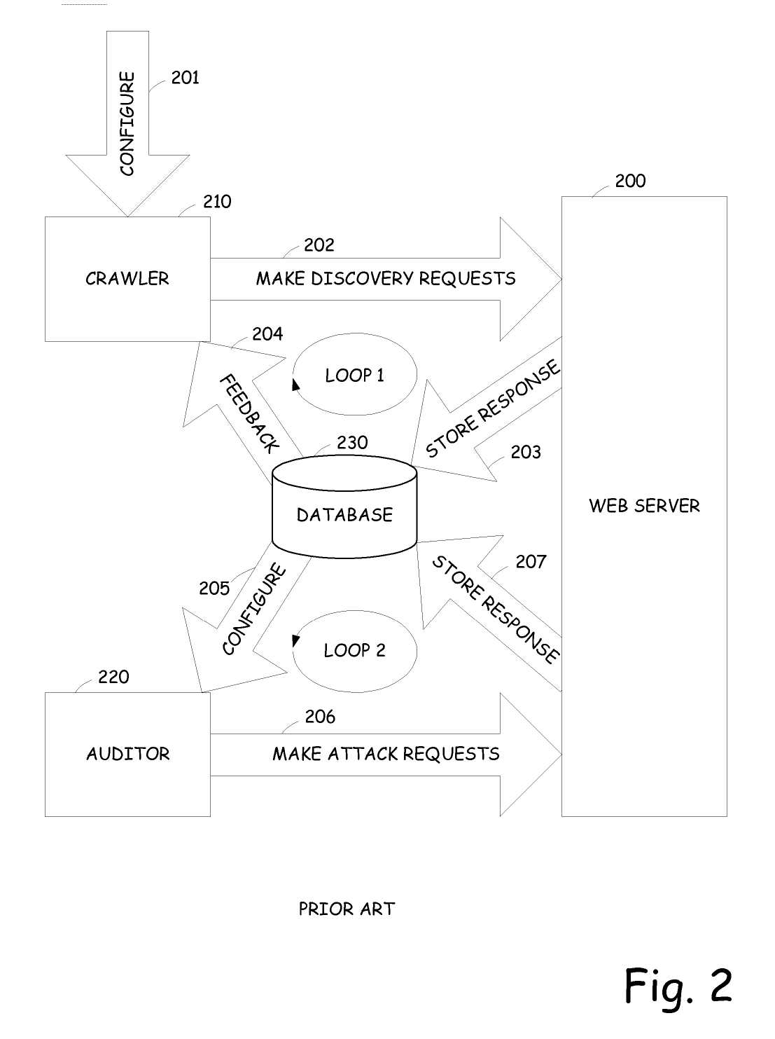

FIG. 3 is a flow diagram illustrating a multi-mode embodiment of the present invention that includes an interactive crawling mode.

FIG. 4 is a flow diagram illustrating an interactive crawl embodiment of the present invention that includes input processing.

FIG. 5 is a flow diagram illustrating a multi-mode embodiment of the present invention in conducting a crawl.

### DESCRIPTION OF THE INVENTION

The present invention is directed towards an integrated crawl and audit vulnerability assessment that advantageously provides vulnerability feedback early in the process even while the crawling process is being executed. In general, the present invention operates by integrating the crawling process and the auditing process in such a manner that they can run simultaneously. Using technology, such as multi-threading, the auditing process can run simultaneous or concurrently with the crawling process and provide vulnerability assessment feedback early during the process. Advantageously, this aspect of the present invention can enable a vulnerability assessment to be terminated early in the process if a severe vulnerability is detected. This allows the vulnerability to be fixed and then reinitiating of the vulnerability assessment without having to spend the vast amount of time to complete the entire crawl, only to discover that a severe vulnerability is present that must be fixed prior to running another vulnerability assessment.

Now turning to the figures in which like labels represent like elements through out the diagrams, various embodiments, aspects and features of the present invention are further described.

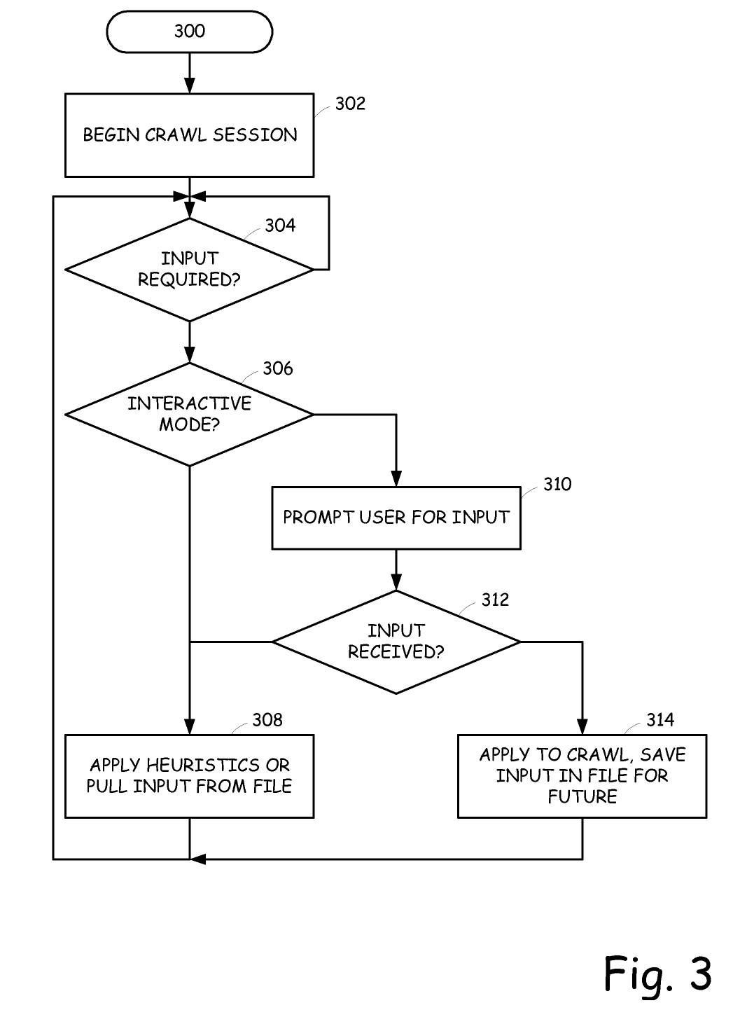

FIG. 3 is a flow diagram illustrating a multi-mode embodiment of the present invention that includes an interactive crawling mode. The process 300 begins at step 302 by initiating the crawl session. During the crawl session, content may be examined that requires values to be inputted or actions to be taken. If such input or action is not required 304, the crawl continues to operate. However, if such input or action is required 304, the mode of the crawler is determined. If the crawler is not in an interactive mode 306, processing continues at step 308 where the input or action is attempted to be resolved automatically by either applying heuristics or pulling predefined inputs from an identified file. However, if the crawler is operating in an interactive mode 306, the crawler pauses and prompts the user (or another process) to provide the input 310. If the input is received 312, processing continues at step 314 to apply the input to the crawl session and to save the input into a file for future use (i.e., upon crawling to this particular point again). If the input is not received then processing continues at step 308 as described above. In one embodiment, a timer can be used to make the determination of when to declare the input as “not being received” and resuming at step 308. In other embodiments, a default user action can be used to indicate that user input is not going to be forth-coming. Processing then continues until the crawl encounters yet another input or action required condition 304.

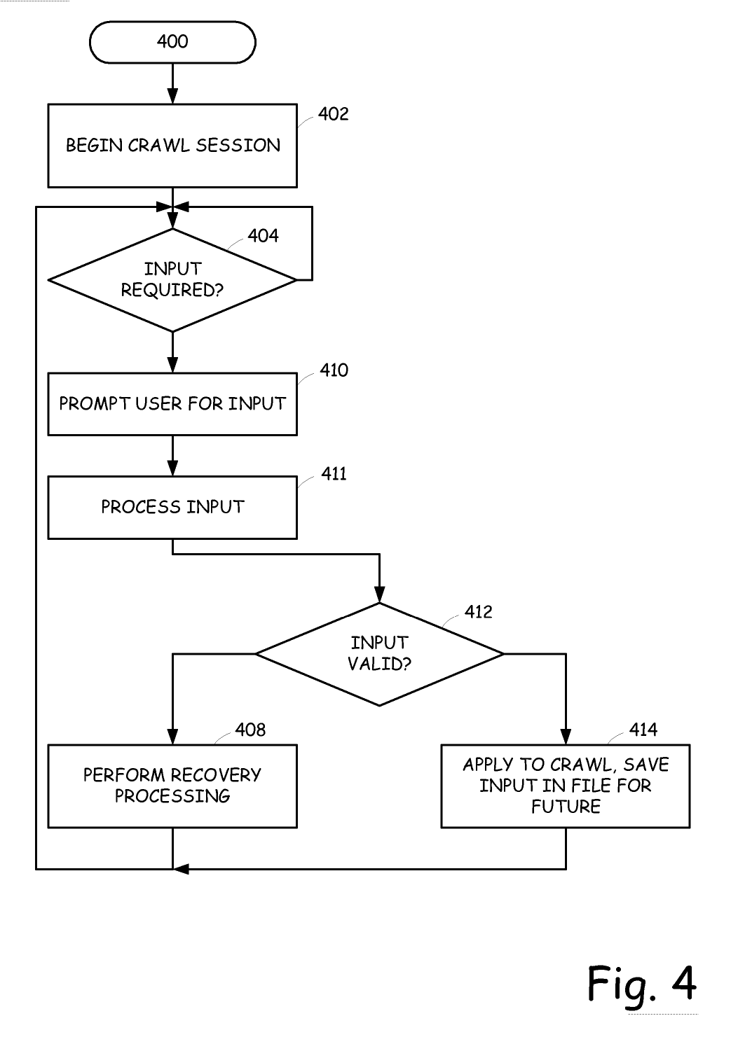

FIG. 4 is a flow diagram illustrating an interactive crawl embodiment of the present invention that includes input processing. The process 400 begins by initiating a crawl session 402. During the crawl session, content may be examined that requires values to be inputted or actions to be taken. If such input or action is not required 404, the crawl continues to operate. However, if such input or action is required 404, the required input or action must be obtained or performed prior to continuing with the crawl session. In a purely automatic crawling process, a crawler would automatically resolve the data input or action requirement issue in one of predetermined set of defined manners. For instance, preloaded files could be used to define a sequence of input values or random number generators could be used to generate input values. In a purely manual process, anytime such an input or action is required, a user or operator is prompted and the crawl does not continue until such input is provided or such action is taken. The interactive mode, as defined by the present invention, is similar to the automatic mode with the exception that the crawl will pause when a form is encountered on a page and the user will be prompted to fill in the input data (rather than automatically generating random data or use the audit default field data from the configuration). It should be appreciated that the term form, as used throughout this description is not limited to simply a field in a web form or a web form itself. The term form also includes other user fillable items, such as but not limited to authorization functions. Thus, one time tokens, username/password requests, NTLM or basic authentication, and the like are all included, jointly and severably, within the definition of form. The visual prompt for input that can be presented to the user may be pre-populated with default values that were present in the input file. In one embodiment of the invention, the user has the option to override only a subset of these inputs if he so desires. If a time out event occurs without receiving input from the user, then the crawl proceeds with the default values.

Once it is determined that some form of input is required, the crawler prompts for the provision of the input or action required 410. Typically this is a prompt targeted towards a user or operator of the crawl process but, it should be understood that the prompt may also be targeted towards another process, system or robot type of a system to provide such input or action. The interactive mode, as defined by the present invention, is similar to the manual mode with the exception that the crawl will not necessarily always rely upon user or human input. At step 411 the input, or the lack thereof, is processed by the crawl process. For instance, in one embodiment of the present invention, the crawl process may reach a form field and prompt the user to input the data. In response, the user may input the exact data to be used to complete the form field, or the user may select to identify a file or process from which the crawl process can obtain such data, or the user may invoke an override to force the crawl process to operate in automatic mode for this particular case. Thus, the input is processed at step 411 to determine if it is an immediate satisfaction of an input requirement or a redirection to obtain the input data from another source or an override request, as well as other options. Advantageously, this aspect of the present invention allows for great flexibility in the interactive crawling process. For instance, suppose the crawling process encounters a human verification requirement. The human verification requirement basically displays a set of characters in a distorted font and requests the user to read the characters and enter them into a text box. Such a feature is used to prevent machines from attacking a site since the machine would not be able to reliably perform the required action. Thus, an automatic crawler, when encountering such a structure, would basically fail unless it was able to randomly select and enter the correct data. Likewise, the use of a preloaded file would not likely result in resolving the input requirements. A manual crawler, when encountering such a structure, would pause and require the user to provide the correct input prior to moving forward. This type of a system allows the crawl process to continue but, it does not provide any flexibility in testing of the structure. The interactive crawl of an embodiment of the present invention will allow a user to enter the data directly, direct the crawl to a file to attempt to satisfy the input requirement from preloaded data, solicit the involvement of a random data generator or another process, etc. Thus, the interactive crawl provides greater flexibility in the operation of the crawl process.

For input that simply requires the provision of data for fields of a form, the interactive crawl in this embodiment may allow a user to enter the data for each field in the form. Alternatively, the forms can be auto-filled (from webform editor-created defaults) by the user simply selecting such an option or, the form fields can be completed by reading a data file created during a previous scan of the site.

At step 412, if the input information is valid, processing continues at step 414 where the input is applied to the crawl process and may or may not be saved into a file for use in future crawling sessions. If the input is not valid, then the crawl may attempt to resolve the data input issue on its own 408 in one embodiment or, may simply attempt to continue the crawl at a different location, if possible, in other embodiments.

As previously mentioned, the present invention may be embodied within a crawler that operates strictly within the interactive crawl mode or, may implement the interactive mode along with one or more other modes of operation. In the former embodiment, the invention operates in accordance with FIG. 4 and pauses for user input at various stages in the scanning process. The pauses typically occur at points that require user input but, may also be when structures are encountered that could greatly lengthen or shorten the duration of the crawl based on user input. At such junctures, the interactive crawl may pause to allow the user the opportunity to direct the crawl in an appropriate manner. For instance, a particular form field, pull-down selection option, radio button selection, etc., may invoke a pause. The user may decide to simply enter a single option and continue the crawl. Alternatively, the user may desire to traverse two or more possible scenarios based on the input data. In such a case, the interactive crawl may provide the user with the option to enter one or more data input response, direct the crawler to a file or random data generator to obtain responses, identify the number of responses the user would like to test and then prompt the user for that number of data values, as well as other similar techniques. Advantageously, this aspect of the present invention allows the crawler to be effective against input data requirements where a variety of inputs may alter the characteristics of the crawl yet, to enable the use to simply enter threshold requirements, such as passwords and human verification responses when encountered.

Other embodiments have been described as including the interactive mode along with one or more other crawling modes. In these embodiments, the crawl can be switched from one mode to the next either by user control or the occurrence of certain triggering events. For instance, if an interactive crawl is in process and the user needs to retire for the evening, the user may switch the crawl to fully automatic mode to ensure that the crawl continues processing through the night or to fully manual mode to ensure that the crawl will stop at the next user input data point and not proceed any further.

Thus, embodiments of the present invention provide a crawl process that is characterized as an interactive crawl or includes an interactive mode that is fully automatic except when encountering forms, login requests, or other pages that cannot be processed without data from the user. Once such situations are encountered, the crawler will pause and wait for the user to enter the requested information, override the requirement, or otherwise resolve the issue. Similarly, some embodiments may utilize a watchdog timer to avoid the occurrence of a Dykstra semaphore or a similar condition in which one or more processes are waiting on input from another process or entity prior to continuing, and thereby allow the crawler to default to random input, input from preloaded file, input from another process or other input to satisfy the input requirement.

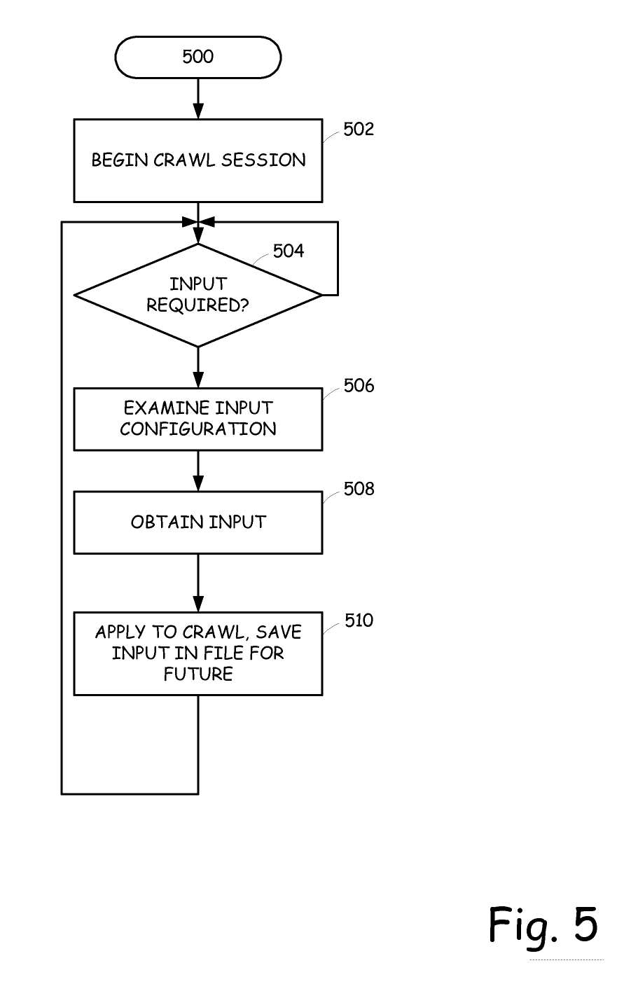

FIG. 5 is a flow diagram illustrating a multi-mode embodiment of the present invention in conducting a crawl. The illustrated process is utilized to demonstrate various embodiments that provide for a multi-mode crawl that at least includes the interactive mode. The process 500 begins when the crawl is initiated 502. It should be appreciated that prior to starting the crawl, the user or operator may perform some initial configuration or setting up of various parameters to define the operation of the crawl. For instance, part of the configuration may include selecting and activating a particular mode, such as interactive, manual, automatic, etc. In addition, the configuration may allow for setting up mode dependencies. For instance, the mode of operation for the crawl can be setup to be dependent upon time. As an example, the crawl can be automatic from 5:00 pm to 8:00 am and interactive from 8:00 am to 5:00 pm. The active mode can also be setup based on various other parameters such as the type of web site being crawled, the particular URL's being accessed, the type of content on the web site and/or web page, etc.

Once the crawl commences, it may encounter a data input requirement 504. When this occurs, the crawling process can then examine the configuration settings for the crawl 506. Depending on the particular configuration settings, the crawl can take different actions. For instance, if the crawl is set to be automatic, the data input requirement may be met by pulling preloaded data from a file or by feeding randomly generated data into the web site. If the crawl is set to be fully manual, then the data input requirement may be a data entry from a user. If the crawl is set to be interactive, then the data input requirement may be a data entry by a user, some other user input to identify a source for the data, or a previously created scan session file if that particular target had previously been crawled. As an example, in one embodiment, the crawler may search for a file created during a previous scan of this web site and if found, attempt to extract the required information. If the file is not found, the crawler can pause and require user interaction. Alternatively, the crawler may find file from a previous search and then request the user to either enter the data or select the file to be used to satisfy the input requirements. In addition, one embodiment may prompt the user to make such selection and if the user does not provide input within a period of time, then default to the use of the content in the previously created file.

Once the data input source and method is identified, the data input is obtained 508 and applied to the crawl process 510.

Now that the general operation of various aspects of the present invention have been presented, an exemplary embodiment and variations thereof are presented to show a suitable environment for implementing one or more of these various aspects of the present invention. In an exemplary embodiment of the present invention, the embodiment operates as a stand-alone windows user interface application that performs web server vulnerability assessment. This embodiment of the present invention overcomes and/or alleviates problems associated with prior art vulnerability assessment tools that were designed to operate in a monolithic fashion where the database, the user interface and the assessment code were all rolled into a single executable file. Such prior art systems were limited by the fact that only a single instance of the program can be running at a given time.

One aspect of this embodiment of the present invention is that it conforms to a classic three-tier design incorporating a user interface layer, an engine layer and a data provider layer. By completely separating the user interface code from the assessment engine (the component framework that does the crawling/auditing) multiple engines can be running on a single platform.

As an example of one embodiment of the present invention, the exemplary implementations of the various components are briefly described along with further detail of the operation of the embodiment.

The user interface component may include the following various interfaces. For instance, the user interface may include a start page for initiating primary tasks such as starting a new scan, generating a report on a completed scan, scheduling a scan, starting a web discovery (find web servers on the network), and opening a recent scan from a list. The user interface may also include a toolbar to expose common commands and/or a hierarchical menu bar to expose common commands. The user interface may also provide a session tree view that can show all crawled and audited URLs and provide context menu on selected nodes in the tree, show summary information about comments, cookies, scripts, client certificates, broken links, and offsite links. The user interface may also provide a sequence view that shows all crawled and audited URLs in the order the requests were made. In addition, the user interface may provide a session details view that shows the following information that pertains to the selected session in the session tree view: vulnerability information, browser view, HTTP request and response raw data, URL links on the page, and form data on the page. The user interface may include: an alerts view that shows all vulnerabilities found during the scan; an Info view that shows miscellaneous details pertaining to the server being scanned, a scan log view that shows scan engine execution details with time stamps, a ‘Best Practices’ view, a dashboard view that shows scan engine performance metrics in graphical form, settings editing controls to allow for detailed engine and scan configuration, and a tools menu that allows the user to launch external tools useful during assessment of a web server. The user interface may also allow the user to subscribe to a scan engine(s) and provide F1-activated help for common tasks.

The scan engine in the exemplary embodiment may provide command and control APIs for: starting/stopping/pausing scans, applying settings, retrieving performance data and retrieving scan data. The scan engine may also provide events to subscribers (client components) to inform them about: crawled URLs, vulnerabilities discovered, logins, logouts detected, file not found conditions, and scan completions. Several other capabilities may be found in the exemplary scan engine including, but not limited to, discovering and loading audit engine plugins and data provider plugins, defining external interfaces for use by data provider plugins and defining external signatures for use by subscribers.

The data provider in the exemplary embodiment may implement the data provider interface defined by the scan engine and create/read/update/delete scan data from a specific third party data store.

The exemplary embodiment can support several usage patterns. One such usage pattern is command line invocation. There are two modes of activating a scan via command line. In the first mode, the user types a line at the prompt and the scan runs unattended until completion. This scenario provides no opportunity for interaction and the user must view a report (if it was generated by the scan) or summary text at the prompt. The second mode is enabled by passing a specific command line switch which puts the user in ‘command mode’. In this mode, the user can issue individual commands and will be notified in real time when interesting events occur (such as vulnerabilities being discovered). This scenario makes use of a separate executable program (not the user interface executable program) which instantiates the scan engine and configures it with settings specified in an external file.

Another usage pattern is a fully automated scan. Fully automated scans are setup and run in the user interface but left unattended until completion. Any form inputs required by pages being audited are provided by a preconfigured file. The user is free to pause and resume the scan but if left alone, the scan will complete without further user intervention.

Another usage pattern is the user interface fully interactive. Interactive scans run just like automated scans except that when the engine discovers a form that requires inputs it pauses and pops up the necessary user interface to collect the input data. After the data is input, the scan returns to automated mode until further input is required or the scan ends.

Another usage pattern is the user interface manual (step) mode. Step mode means that the user is solely responsible for navigating the site using a browser. The visited URLs are captured and audited automatically, but the complete crawl feature of automated scans is missing.

Another usage pattern is the automated scan with intermittent user interaction. A common scenario is for a user to run an automated scan but to watch the user interface as sessions are added to the site tree. In this case, the user may notice something of particular interest (a specific vulnerability found on a page for example) and choose to crawl and audit the site from that URL (crawl the URL and its children). In this case, the engine is sensitive to the user interface initiated crawl and suspends all automated crawling except that which resulted from the user selecting a URL and choosing crawl. When this operation completes, the scan engine resumes normal automated scanning.

Another usage pattern is scheduled scanning. The windows scheduler can be configured to start scans at pre-selected times. The scheduler simply invokes the command line utility to start the scan. The user interface executable program will provide scheduling screens that result in proper configuration of the windows scheduler service.

Finally, a remote invocation by AMP usage pattern may be included. The scan engine can be instantiated by an AMP sensor and used to control a scan. Alternatively, a ‘listener’ service that is installed with system can create an instance (in non-interactive mode) and configure it to take commands from AMP.

The exemplary embodiment of the present invention can perform vulnerability assessment on web servers by crawling and auditing in an integrated fashion. The scan engine can be instantiated and controlled by any .NET client code including (but not limited to): the user interface, the command tool line of the user interface, AMP sensors, visual studio add-in packages and QA product add-in modules.

Those skilled in the art will appreciate that crawling is the act of making HTTP requests, parsing the responses for additional URL links and recursively crawling those links as well. This process is automated and continues until all links have been requested. The crawler process in the present invention is a reusable .NET assembly that makes use of multi-threading and concurrent IO (multiple outstanding web requests). Crawling speed is an important aspect of any vulnerability assessment tool and the present invention operates to provide a scalable crawling architecture. Scalable crawling involves multiple crawlers (perhaps on multiple machines) conducting a coordinated navigation of an entire site under the control of a single crawl manager. Although the present invention is primarily described as only supporting a single crawler and crawl manager, it is anticipated that the present invention can also be incorporated into a distributed crawling environment or utilize multiple crawling processes.

Parsing links from responses is an important part of crawling. The present invention introduces several novel link parsers to maximize the number of links that crawls can find and supports proper multi-language (character set) decoding.

Those skilled in the art will also appreciate that auditing includes the process of programmatically examining HTTP request/response pairs—called sessions—and then sending additional HTTP requests for the purpose of attacking a web server. Successful attacks can result in vulnerability information that causes further auditing (more refined attacks) and/or further crawling (following new links found by the audits). Audit types are numerous and varied and more methodologies are discovered as time goes by, therefore, embodiments of the present invention include the ability for plugin audit engines. This aspect of the present invention allows incorporation of .Net assemblies that contain code designed to attack a web server in a very specific way (configurable by policies). These assemblies are discovered at runtime and the set of audit types can be extended via smart update. Smart update is an aspect of the present invention that enables the scan engine to understand plugin binaries and the versioning issues associated with them. Auditing is time consuming and large sites can demand distributed audits to efficiently perform the audit process. The various aspects of the present invention can be incorporated into and anticipate the use of distributed audits. In such an embodiment, a single audit manager coordinates the efforts of multiple auditor processes (perhaps on different machines). A single auditor discovers the set of policy-selected audit engines to use for attacking the web server. Although the present invention is primarily described as using a single auditor process and audit manager, multiple and/or distributed auditor processes are also anticipated.

It will be appreciated that the above described methods and embodiments may be varied in many ways, including, changing the order of steps, and the exact implementation used. The present invention has been described using detailed descriptions of embodiments thereof that are provided by way of example and are not intended to limit the scope of the invention. The described embodiments comprise different features and aspects, not all of which are required in all embodiments of the invention. Some embodiments of the present invention utilize only some of the features or aspects or possible combinations of thereof. Variations of embodiments of the present invention that are described and embodiments of the present invention comprising different combinations of features noted in the described embodiments will occur to persons of the art. The scope of the invention is limited only by the following claims.

What is claimed is:

1. A method for performing a crawl of a target, the method comprising the steps of:
initiating a crawling process on the target;
encountering a structure that requires data input;
prompting a user to respond to the requirement for data input;
receiving the response from the user;
applying the user response in satisfaction of the data input requirement for the crawling process; and
storing the data input in a file accessible by the crawler on future scans of the target.

2. The method of claim 1, wherein the step of applying the user response in satisfaction of the data input requirement comprises utilizing the user response to satisfy the requirement of the data input.

3. The method of claim 1, wherein the step of applying the user response in satisfaction of the data input requirement comprises utilizing the user response to identify a source of data to satisfy the requirement of data input.

4. The method of claim 1, wherein the user response is a request to override the requirement for data input and to operate in an automatic crawling mode.

5. The method of claim 1, wherein the user response is an absence of a response resulting in a time-out event and an alternate source of data is used to satisfy the requirement of data input.

6. A method for performing a crawl of a target, the method comprising the steps of:
initiating a crawling process on the target;
encountering a structure that requires data input;
identifying the mode of operation for the crawling process;
if the mode of operation is the interactive mode:
prompting a user to respond to the requirement for data input;
if a response is received from the user, applying the user response in satisfaction of the data input requirement for the crawling process; and
storing the data input in a file accessible by the crawler on future scans of the target.

7. The method of claim 6, further comprising the step of, if the mode of operation is the automatic mode, generating random data to satisfy the requirement for data input.

8. The method of claim 6, further comprising the step of, if the mode of operation is the automatic mode, obtaining data from a pre-loaded file to satisfy the requirement for data input.

9. The method of claim 6, further comprising the step of, if a response is not received from the user, applying a default data input source in satisfaction of the data input requirement.

10. The method of claim 9, wherein the default data input source is a random data generator.

11. The method of claim 9, wherein the default data input source is a pre-loaded file of data.

12. The method of claim 9, wherein the default data input source is a process.

13. The method of claim 6, further comprising the step of, if the mode of operation is the manual mode, stopping the crawling process until the user provides a response to the requirement for input data.

14. The method of claim 6, wherein the step of identifying the mode of operation of the crawling process comprises examining a schedule identifying a mode of operation for a particular scheduled time.

15. The method of claim 6, wherein the step of identifying the mode of operation of the crawling process comprises identifying the type of target and selecting a mode of operation based on the type of target.

16. A method for performing a crawl of a target, the method comprising the steps of:
initiating a crawling process on the target;
encountering a structure that requires data input;
identifying the mode of operation for the crawling process;
if the mode of operation is the interactive mode:
prompting a user to respond to the requirement for data input;
if a response is received from the user, applying the user response in satisfaction of the data input requirement for the crawling process; and
storing the data input in a file accessible by the crawler on future scans of the target; and
if the mode of operation is the automatic mode:
satisfying the input data requirement by obtaining data from a pre-loaded file.

17. The method of claim 16, further comprising the step of, if the mode of operation is the interactive mode and a response is not received from the user, applying a default data input source in satisfaction of the data input requirement.

18. The method of claim 17, wherein the default data input source is a random data generator.

19. The method of claim 17, wherein the default data input source is a pre-loaded file of data.

20. The method of claim 16, further comprising the step of, if the mode of operation is the interactive mode and the response received from the user is an override request, operating the crawling process in automatic mode with regards to the data input requirement.
